(19) United States
(12) Patent Application Publication
(10) Pub. No.: US 2008/0251752 A1
(43) Pub. Date: Oct. 16, 2008

(54) Fire Extinguishant, Method for Its Manufacture and Method for Fire Extinguishing

(75) Inventor: Jan Borch, Trondheim (NO)

Correspondence Address: DENNISON, SCHULTZ & MACDONALD, 1727 KING STREET, SUITE 105, ALEXANDRIA, VA, 22314, US

(73) Assignee: THERMOS AS, Trondheim (NO)

(21) Appl. No.: 12/066,891

(22) PCT Filed: Sep. 22, 2006
(86) PCT No.: PCT/NO06/00324

§ 371 Date: May 27, 2008

(30) Foreign Application Priority Data
Sep. 28, 2005 (NO) 20054482

(51) Int. Cl. A62D 1/00; A62D 1/06

(52) U.S. Cl. 252/7; 252/8.05; 516/98; 169/46

(57) ABSTRACT

Fire extinguishant and method for its manufacture comprising carbonate material which is present in a finely ground or crystalline/ precipitated form in a mixture with an aqueous carrier medium, preferably I the form of a homogenous dispersion. Method for extinguishing fire by spraying application of such a fire extinguishant is also disclosed.

### BACKGROUND

Development of a beginning fire to an uncontrollable fire depends on the availability of oxygen or an oxidant at the combustible material so that oxidation reactions may take place to an uncontrolled extent. Oxidation reactions release heat which converts the ignited material to unstable chemical components which again may react with an available oxidant in an unstable course and produce more heat until the availability of oxidant becomes the limiting factor for the fire development.

A beginning fire can be controlled in one of three manners:

1. Reducing the availability of oxidant (choking effect)

2. Reducing the heat development by addition of chemical components to the fire site which at high temperatures undergoes energy demanding chemical reactions or physical conversions (cooling effect).

3. Terminating the oxidation reactions by adding chemical compounds that form stable chemical molecules by reaction with the unstable chemical components from the fire (terminating effect). The termination results in a break of the unstable chemical cycle: heat =>unstable material=>combustion=>heat.

Conventional fire extinguishing with water is primary of the cooling type 2. The physical conversion from liquid water to vapour is energy demanding and reduces the energy development in the fire. Fire extinguishing by means of different types of foam will typically be of type 1, i.e. a choking manner of operation. The foam forms an only partly permeable physical barrier between the burning material and the surrounding air oxygen which leads to a choking of the fire due to reduced oxygen supply through the foam layer. CO2 and water vapour are other examples of materials that can have a choking effect on a fire.

Water fog may have a combination of a cooling and choking effect on a fire. Powders containing sodium bicarbonate or halides are examples of fire extinguishants with a terminating manner of operation.

Ground limestone (calcium carbonate) in the form of limestone flour is a well known safety precaution in coal mining. Explosion like fires may be choked by spraying such limestone flour in the air. On strong heating the limestone will chemically decompose: CaCO₃=>CaO+CO₂. This decomposition reaction is energy demanding and therefore has a cooling effect. In addition the CO₂ formed reduces the oxygen concentration in the air and thereby provides a choking effect.

Carbonate materials are also known to be fire retardants and are used for surface treatment of combustible materials.

U.S. Pat. No. 5,695,691 is an example, describing colloidal particles of solid material fire retardants dispersed in water, organic liquids or fusible solid materials. The patent concerns finely ground particles of materials that provide fire retardant properties to fibres, textiles, paper, paint, insulation etc.

Japanese patent No. JP2000107319 describes a “fire extinguishing chemical” in which fire extinguishants of terminating type comprising carbon halides or hydrocarbon halides are mixed with alkaline components, e.g. calcium carbonate. The purpose of such a mixture is to neutralize the harmful hydrogen halides (e.g. HCl) that results from use of halides as fire extinguishants.

U.S. Pat. No. 4,560,485, under the title “Fire fighting powders” presents powders for fire extinguishing comprising various carbonate-bicarbonate mixtures (so-called sesqui-carbonates). The US patent describes use of powders of sesqui-carbonates of sodium, potassium or ammonium.

### OBJECTIVE

It is an object of the present invention to provide a fire extinguishant that is effective in many situations where a beginning fire is seen, by utilizing in a more efficient manner than the previously known methods, a combination of a choking, cooling and terminating effect.

It is furthermore an object to do this with simple means and to provide an extinguishant which is cheap to manufacture and which is simple, non-hazardous and environmentally friendly to store and handle.

### THE PRESENT INVENTION

According to a first aspect the invention provides a fire extinguishant as defined by claim 1.

According to a second aspect the invention the invention provides a method for the manufacture of a fire extinguishant as defined by claim 10.

According to a third aspect the invention provides a method for extinguishing a fire as defined by claim 14.

Preferred embodiments of the invention are disclosed by the dependent claims. By “finely ground particle materials” as used herein is understood that at least 50% of the particles on a number basis have a largest diameter less than 0.5 mm and preferably less than 0.1 mm. The particles will in practice never be completely spherical and the term “largest diameter” should be understood as the largest one-dimensional extension irrespective of the actual particle shape. Choice of particle size will influence how easily the particles remain in suspension or dispersion, short-term and long-term.

Particles with a desired size will typically be ground particles but may also be precipitated, crystalline particles. The mixture will typically have the form of a homogenous dispersion or suspension which in many cases constitutes a preferred embodiment. The mixture may, however, have rheological properties implying that it assumes the form of a gel when not exposed to agitation (shear) but again goes back to a non-viscous dispersion when agitated. This way it is ensured that the particles do not settle but remain evenly distributed in the mixture during storage.

The carbonate material may e.g. be derived from limestone, marble, shell sand, and coral line sediment (mainly calcium carbonate), dolomite (combinations of calcium carbonate and magnesium carbonate) or from deposits of soda materials (sodium carbonate and/or sodium bicarbonate).

The carbonate material should either be so finely ground or micronised that sedimentation can be avoided without agitation or agitation should be used as an alternative means to hold the carbonates dispersed during storage and transportation. Surface active compounds (dispersants) may be added to the dispersion to help avoiding sedimentation or to facilitate foaming or to provide the dispersion with a gel structure. Biocides may be added to enable biological stability to be maintained over time. Heat resistant fibres may be added to the dispersion to increase its mechanical strength when the dispersion sets/ dries.

According to the second aspect of the invention a fire extinguishant is manufactured by grinding a carbonate containing material to finely ground particles with a number average largest diameter less than or equal to 0.5 mm, preferable less than or equal to 0.1 mm. The finely ground carbonate particles is suspended or dispersed in water or in an aqueous solution. The water may be freshwater or salt water, hereunder seawater. To the extent that the water comprises other components such as dispersants, fire retardant fibres or other active or passive components, these may be present in the water before the carbonate material is added, such components may be added simultaneously with the carbonate material or such components may be added after the carbonate material has been added to and spread in the water. With “passive components” is herein understood components that do not influence the dispersions ability to extinguish fire.

When in this description we refer to low viscosity this should be interpreted as a viscosity sufficiently low to allow use of with ordinary pumping and spraying equipment to spread the dispersion onto a fire location.

The third aspect of the invention is a method for extinguishing fire in which the characterising features are analogues to the first aspect of the invention, namely the fire extinguishant to be used for the purpose.

By spraying a fire extinguishant according to the present invention the following effects are obtained:
The water content in the dispersion or mixture will rapidly decrease by water evaporation. Thereby a cooling effect is obtained.
When a sufficient amount of water has evaporated, the dispersion or mixture is converted to an applied layer of a solid carbonate material which will act as a barrier with respect to the oxygen transportation from the surrounding air to the combustible material. This involves a certain choking effect.
After a sufficient heating from the fire of the applied layer the carbonates will decompose and release CO₂. This both provides a cooling effect by the energy demanding, chemical decomposition and it provides a choking effect by the fact that the CO₂ released during decomposition displaces air and thereby oxygen.

The fire extinguishant according to the present invention can in one out of several possible embodiments be supplied to the fire in the same manner as water, by traditional pumps and fire hoses. Compared to traditional fire extinguishing a certain amount of fire extinguishant applied will have the same effect as a substantially larger amount of water with no carbonate content. Tests have shown that the dispersion has an immediate fire extinguishing effect on burning car tires, house fires and bonfires of various materials. Alternative methods for application of the carbonate dispersion includes, without excluding other methods not mentioned herein, application in the form of an atomised dispersion, application in the form of a gel, application in the form of foam and application in the form of a fibre-enriched dispersion. When the carbonate dispersion is applied as an atomised dispersion it is supplied in liquid form through an atomising nozzle. When it is applied as a gel, foam or with fibre enrichment it is supplied with an addition of a gelling agent, a foaming agent and fibre suspension respectively, either added directly to the suspension prior to its application or added as a second component of a two component dispersion mixture during application.

To allow the dispersion to be added without problems with sedimentation of particles, finely ground carbonate particles with a sufficiently small particle size to avoid sedimentation even without agitation can be used or storage and transportation may be performed with equipment that provides agitation to avoid sedimentation. High particle surface has a positive influence on the reactivity of the fire extinguishant, thus in addition to the particle size the porosity of the particles influences on their efficiency. This means that larger agglomerates of smaller particles which e.g. may be formed during crystallization/ precipitation of synthetic carbonates, resulting in large internal surfaces, may be as effective as finer particles.

In order to avoid sedimentation during storage and transportation when agitation is not provided, surface active dispersants may be added. Examples of such dispersants are, without limitation to the dispersants mentioned, derivatives of acrylic acid or components as mentioned in U.S. Pat. No. 5,076,846.

In order to avoid biological degradation of the dispersion during storage and transportation biocides may be added.

The purity of the carbonates is not critical for the use according to the present invention.

Typical impurities in the carbonates are graphite, silicates, mineral oxides or other minerals as well as remains of organic or inorganic chemicals from industrial treatment processes.

Typical examples of areas of utilization without excluding other fire extinguishing utilizations are tunnel fires, fires in pipelines for oil and gas, forest fires, pit fires, fires in houses and buildings, hereunder external fires, fires in rooms and other internal compartments, fires in electrical and other technical installations, and fire in load-bearing constructions. The fire extinguishant of the present invention is also well suited for fires on platforms and other installations for oil and gas, fires in industrial installations and warehouses, fires on board ships, in trains, airplanes and cars as well as in waste disposal landfills.

1. Fire extinguishant comprising carbonate material, characterized in that the carbonate material is present in finely ground or crystalline/precipitated form in a mixture with an aqueous carrier.

2. Fire extinguishant as claimed in claim 1, characterized in that it has the form of a substantially homogenous dispersion or suspension.

3. Fire extinguishant as claimed in claim 1, characterized in that the carbonate material comprises minerals chosen among the group comprising limestone, marble, shell sand, coral line sediment (mainly calcium carbonate), dolomite, (a combination of calcium carbonate and magnesium carbonate) or from deposits of soda materials (sodium carbonate and/or sodium bicarbonate) or any combination of two or more thereof.

4. Fire extinguishant as claimed in claim 1, characterized in that it further comprises per se known additives chosen among dispersing agents, biocides, foaming agents, gelling agents and heat resistant fibres.

5. Fire extinguishant as claimed in claim 1, characterized in that the carbonate material has a number average largest diameter less than or equal to 0.5 mm.

6. Fire extinguishant as claimed in claim 1, characterized in that the carbonate material has a number average largest diameter less than or equal to 0.1 mm.

7. Fire extinguishant as claimed in claim 1, characterized in that it during storage is able to assume the form of a gel structure while under agitation it assumes the form of a low-viscosity dispersion.

8. Fire extinguishant as claimed in claim 1, characterized in that the carbonate material is present in an amount in the range from 2% to 90% by weight of the water in the dispersion, preferably from 5 to 70%.

9. Fire extinguishant as claimed in claim 1, characterized in that it has the form of a gel, foam, a fibre-enriched dispersion, or an atomised dispersion.

10. Method for the manufacture of a fire extinguishant, characterised in that a carbonate material is ground to particles with a number average size (largest diameter) less than 0.5 mm and that a carrier medium in the form of water or an aqueous solution is added to the grounded particles, alternatively that the carbonates are made synthetically from correspondingly dissolved oxides or hydroxides by addition of carbon dioxide and subsequent crystallization/agglomeration and dewatering to a desired solids concentration.

11. Method as claimed in claim 10, characterized in that a carbonate material comprising at least one mineral chosen from the group consisting of limestone, marble, shell sand, coral line sediment (mainly calcium carbonate), dolomite (combination of calcium carbonate and magnesium carbonate), or from deposits of soda materials (sodium carbonate and/ or sodium bicarbonate).

12. Method as claimed in claim 10, characterized in that a dispersing agent is added to the fire extinguishant alternatively that the fire extinguishant is agitated to ensure that is has the form of a substantially homogenous dispersion of carbonate material in an aqueous carrier medium.

13. Method as claimed in claim 10, characterized in that one or more carbonate materials is/are added until the concentration thereof is in the range from 2% to 90% by weight of the water in the dispersion or mixture.

14. Method for extinguishing fire, characterized in applying to the fire site an aqueous mixture of a finely ground carbonate material.

15. Method as claimed in claim 14, characterized in that the aqueous solution has the form of a dispersion that is applied to the fire site by means of conventional spraying equipment for water or aqueous liquids.

16. Method as claimed in claim 14, characterized in that the aqueous mixture has the form of an atomised dispersion and is applied to the fire site by suitable means therefore.
